(19) United States
(12) Patent Application Publication
(10) Pub. No.: US 2026/0118478 A1
(43) Pub. Date: Apr. 30, 2026

(54) METHOD AS WELL AS TEST AND/OR MEASUREMENT SYSTEM FOR TESTING PHASE-BASED RANGING

(71) Applicant: Rohde & Schwarz GmbH & Co. KG, Muenchen (DE)

(72) Inventor: Nirmalan THIRUVADIVEL, Fleet (GB)

(21) Appl. No.: 18/930,415

(22) Filed: Oct. 29, 2024

(51) Int. Cl. G01S 7/40; G01S 13/36

(52) U.S. Cl. CPC G01S 7/4082; G01S 13/36

(57) ABSTRACT

A method of testing phase-based ranging includes the following. A respective first phase correction term in response to a channel sounding procedure is measured for a first carrier frequency of a carrier signal by a device under test and a test and/or measurement instrument, respectively. A first channel phase offset is calculated for the first carrier frequency based on the measured first phase correction terms. A respective second phase correction term is measured for a second carrier frequency of the carrier signal by the device under test and the test and/or measurement instrument, respectively. A second channel phase offset is calculated for the second carrier frequency based on the measured second phase correction terms. A phase is altered in order to emulate a different distance between the test and/or measurement instrument and the device under test. Further, a test and/or measurement system is described.

### FIELD OF THE DISCLOSURE

Embodiments of the present disclosure relates to a method of testing phase-based ranging. Further, embodiments relate to a test and/or measurement system for testing phase-based ranging.

### BACKGROUND

In the state of the art, it is known to test a device under test by a test and/or measurement instrument for different distances between the device under test and the test and/or measurement instrument in order to verify a distance calculation algorithm. The distance calculation algorithm is typically used in mobile devices in order to enable these mobile devices to determine distances to certain objects, e.g. other communication partners. Consequently, it is necessary to test these distance calculation algorithms with respect to their functionality.

This kind of testing however is time-consuming and prone to failure since an operator has to manually adapt the distance between the device under test and the test and/or measurement instrument for the different tests. For instance, the manually adapted real distance may differ to the expected one which causes failures.

Consequently, there is a need for a more user-friendly and efficient way to test a distance calculation algorithm of a device under test.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

Embodiments of the present disclosure provide a method of testing phase-based ranging. In an embodiment, a respective first phase correction term in response to a channel sounding procedure is measured for a first carrier frequency of a carrier signal by a device under test and a test and/or measurement instrument, respectively. A first channel phase offset is calculated for the first carrier frequency based on the first phase correction terms measured by the device under test and the test and/or measurement instrument, respectively. A respective second phase correction term is measured for a second carrier frequency of the carrier signal by the device under test and the test and/or measurement instrument, respectively. A second channel phase offset is calculated for the second carrier frequency based on the second phase correction terms measured by the device under test and the test and/or measurement instrument, respectively. A phase is altered in order to emulate a different distance between the test and/or measurement instrument and the device under test.

Embodiments of the present disclosure also provide a test and/or measurement system for testing phase-based ranging. The test and/or measurement system comprises, for example, a device under test and a test and/or measurement instrument. In an embodiment, the device under test is configured to measure a first phase correction term in response to a channel sounding procedure for a first carrier frequency of a carrier signal. The test and/or measurement instrument is configured to measure a first phase correction term in response to a channel sounding procedure for a first carrier frequency of a carrier signal. The test and/or measurement system is configured to calculate a first channel phase offset for the first carrier frequency based on the first phase correction terms measured by the device under test and the test and/or measurement instrument respectively. The device under test is configured to measure a second phase correction term for a second carrier frequency of the carrier signal. The test and/or measurement instrument is configured to measure a second phase correction term for a second carrier frequency of the carrier signal. The test and/or measurement system is configured to calculate a second channel phase offset for the second carrier frequency based on the second phase correction terms measured by the device under test and the test and/or measurement instrument respectively. The test and/or measurement system is configured to alter a phase in order to emulate a different distance between the test and/or measurement instrument and the device under test.

Generally stated, the main idea is to use the channel sounding procedure together with altering the phase in order to emulate a different distance between the test and/or measurement instrument and the device under test. The channel sounding can be used to accurately calculate the (physical) distance between the device under test and the test and/or measurement instrument by using a phase-based ranging. Since the phase is actively altered, a different distance can be emulated than the physical distance between the test and/or measurement instrument and the device under test. Therefore, the distance between the test and/or measurement instrument and the device under test can be altered for testing the distance calculation algorithm without physically changing the distance between the test and/or measurement instrument and the device under test. Thus, the risk of failure can be reduced since an operator does not have to manually adapt the distance. Moreover, the testing is less time-consuming since a manual adaption of the distance between the test and/or measurement instrument and the device under test is not necessary anymore.

Accordingly, the accuracy of the distance calculation algorithm can be tested across a wider and more granular range of distances without physically altering the physical test setup, namely the physical distance between the test and/or measurement instrument and the device under test. This can be ensured since the phase can be altered in a more granular manner than the physical distance.

In an embodiment, the device under test and the test and/or measurement instrument each measure phase correction term in response to a channel sounding procedure. In channel sounding procedures, the devices involved, namely the device under test and the test and/or measurement instrument, exchange tones (unmodulated carrier signals) across multiple channels. In general, the phase of the received tones at both devices involved can be used to calculate the distance between the devices involved. By actively altering the phase, a distance can be emulated that is different to the physical distance, namely the real distance between the devices involved, namely the device under test and the test and/or measurement instrument.

Afterwards, the phase correction terms are used to calculate channel phase offset, which is indicative of the distance. As indicated above, by actively altering the phase the channel phase offset is altered, causing a different distance, namely the emulated distance that differs from the physical distance.

In some embodiments, the respective steps are done for different carrier frequencies of the carrier signal, namely at least a first carrier frequency and a second carrier frequency.

An aspect provides that the device under test, for example, is an initiator of the channel sounding procedure, and wherein the test and/or measurement instrument, for example, is a reflector of the channel sounding procedure. Hence, the device under test initiates the channel sounding procedure by transmitting a tone with a certain carrier frequency. The test and/or measurement instrument as reflector measures the phase correction term in response to the tone transmitted by the device under test. Afterwards, the test and/or measurement instrument transmits a tone with a certain carrier frequency based on which the device under test measures the phase correction term in response to the tone transmitted by the test and/or measurement instrument. Then, the test and/or measurement instrument transmits its phase correction term to the device under test, thereby enabling the device under test to calculate the channel phase offset based on the phase correction terms. These steps are repeated for different carrier frequencies. For emulating the distance, a phase is altered during these steps.

Another aspect provides that the test and/or measurement instrument, for example, is an initiator of the channel sounding procedure, and wherein the device under test, for example, is a reflector of the channel sounding procedure. Hence, the test and/or measurement instrument initiates the channel sounding procedure by transmitting a tone with a certain carrier frequency. The device under test as reflector measures the phase correction term in response to the tone transmitted by the test and/or measurement instrument. Afterwards, the device under test transmits a tone with a certain carrier frequency based on which the test and/or measurement instrument measures the phase correction term in response to the tone transmitted by the device under test. Then, the test and/or measurement instrument transmits its phase correction term to the device under test, thereby enabling the device under test to calculate the channel phase offset based on the phase correction terms. These steps are repeated for different carrier frequencies. For emulating the distance, a phase is altered during these steps.

In an embodiment, the phase is altered by the test and/or measurement instrument when forwarding the carrier signal to the device under test. Hence, the test and/or measurement instrument is configured to alter the phase when forwarding the carrier signal to the device under test. In case the test and/or measurement instrument is the initiator, the test and/or measurement instrument may alter the phase when forwarding the tone with the carrier frequency to the device under test during the first step. In case the test and/or measurement instrument is the reflector, the test and/or measurement instrument may alter the phase when forwarding the tone with the carrier frequency to the device under test after measuring its phase correction term in response to the channel sounding procedure initiated by the device under test, namely during a third step.

For instance, the phase is altered by the test and/or measurement instrument when forwarding the phase correction term measured by the test and/or measurement instrument to the device under test. Hence, the test and/or measurement instrument is configured to alter the phase when forwarding the phase correction term measured by the test and/or measurement instrument to the device under test. In case the test and/or measurement instrument is the initiator, the test and/or measurement instrument may alter the phase when forwarding the phase correction term to the device under test after measuring its phase correction term in response to the carrier signal transmitted by the device under test, e.g. during a fifth step. In case the test and/or measurement instrument is the reflector, the test and/or measurement instrument may alter the phase when forwarding its phase correction term to the device under test after the device under test has measured its phase correction term, namely during a fifth step.

In some embodiments, the phase may be altered, e.g. by the test and/or measurement instrument, for the first carrier frequency and/or the second carrier frequency. Hence, the test and/or measurement instrument is configured to alter the phase for the first carrier frequency and/or the second carrier frequency. The phase is altered for emulating the different distance. Since several carrier frequencies are used for testing, the phases are altered for the different frequencies such that the emulated distance is tested for the different carrier frequencies.

Another aspect provides that a phase offset, for example, is added when the phase is altered. Hence, the test and/or measurement instrument is configured to add a phase offset when the phase is altered. The phase offset is added to the actually measured phase for emulating the distance that is different to the physical distance.

In an embodiment, the phase may be altered for emulating an emulated distance between the device under test and the test and/or measurement instrument, which is different to the physical distance between the device under test and the test and/or measurement instrument, thereby obtaining a measurement value for the emulated distance. Hence, the test and/or measurement instrument is configured to alter the phase for emulating an emulated distance between the device under test and the test and/or measurement instrument, which is different to the physical distance between the device under test and the test and/or measurement instrument, thereby obtaining a measurement value for the emulated distance. Generally, the channel sounding procedure can be used for calculating the distance between the devices involved, namely the device under test and the test and/or measurement instrument. By altering the phase, e.g. adding the phase offset, a distance different to the real distance can be emulated such that the device under test, for example its distance calculation algorithm, can be tested for different distances without changing the physical setup, namely the physical distance.

According to another aspect, the phase correction term, for example, is measured for more than two different carrier frequencies and/or wherein the channel phase offset is calculated for more than two different carrier frequencies. In an embodiment, several carrier frequencies may be used for testing the device under test.

A further aspect provides that different distances, for example, are tested without changing a physical setup comprising the device under test and the test and/or measurement instrument. Accordingly, the steps indicated above can be repeated for several different phase offsets added. In other words, the phase is altered several times in a different manner so as to provide the different (emulated) distances which are used for testing the device under test.

In an embodiment, the channel sounding procedure comprises a Bluetooth Low Energy (LE) channel sounding. Bluetooth Low Energy is a technique which makes use of channel sounding. Consequently, the device under test may relate to a Bluetooth Low Energy device under test.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows an overview of a test and/or measurement system for testing phase-based ranging according to an embodiment of the present disclosure, which is used for performing a representative method of testing phase-based ranging according to an embodiment of the present disclosure;

FIG. 2 schematically shows an overview of a test and/or measurement system for testing phase-based ranging according to another embodiment of the present disclosure, which is used for performing a representative method of testing phase-based ranging according to another embodiment of the present disclosure; and

FIG. 3 schematically shows an example overview of how distance calculation is carried out based on tone exchange.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

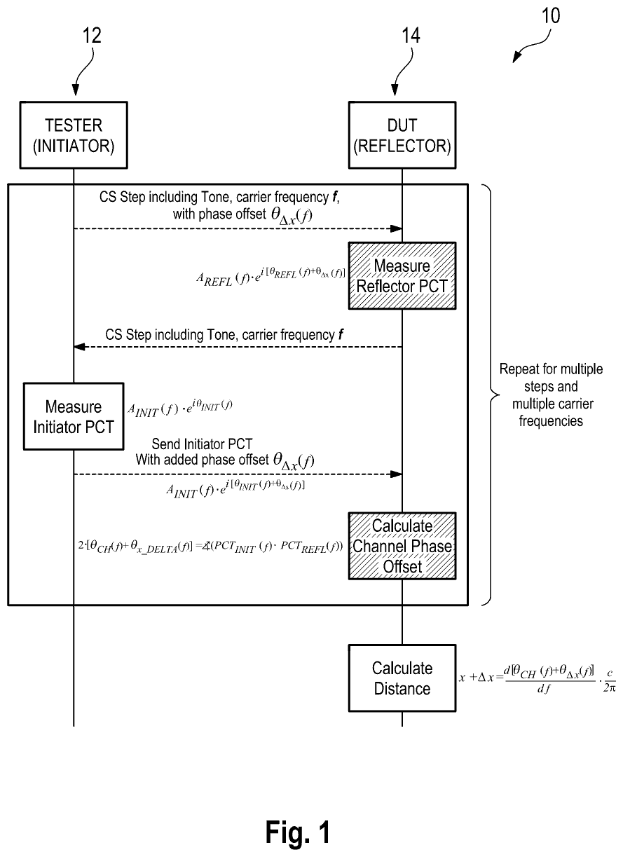

FIG. 1 schematically shows an example embodiment of a test and/or measurement system 10 for testing phase-based ranging. The test and/or measurement system 10 comprises a test and/or measurement instrument 12 and a device under test 14. In the shown embodiment, the test and/or measurement instrument 12 is an initiator whereas the device under test 14 is a reflector.

In a first step that relates to a channel sounding (CS) step, the test and/or measurement instrument 12 transmits a tone with carrier frequency to the device under test 14. Moreover, the test and/or measurement instrument 12 alters the phase by a phase offset θ_{Δx}(ƒ) in order to emulate a different distance between the test and/or measurement instrument 12 and the device under test 14.

In a second step, the device under test 14 measures its phase correction term (PCT) in response to the channel sounding procedure initiated by the test and/or measurement instrument 12. Due to the phase offset θ_{Δx}(ƒ) added, the phase correction term (PCT) is measured for a different phase.

In a third step that relates to a channel sounding (CS) step, the device under test 14 transmits a tone with carrier frequency to the test and/or measurement instrument 12.

In a fourth step, the test and/or measurement instrument 12 measures its phase correction term (PCT) in response to the channel sounding procedure initiated by the device under test 14.

In a fifth step, the test and/or measurement instrument 12 forwards its phase correction term (PCT) to the device under test 14, but alters the phase, namely by adding a phase offset θ_{Δx}(ƒ) to the phase correction term. In some embodiments, the same phase offset θ_{Δx}(ƒ) is added as used in the first step.

In a sixth step, the device under test 14 having both its own phase correction term (PCT) as well as the phase correction term (PCT) of the test and/or measurement instrument 12 calculates a channel phase offset.

In a seventh step, the device under test 14 calculates a distance, by using its distance calculation algorithm, thereby arriving at the emulated distance due to the altered phase, namely the phase offset θ_{Δx}(ƒ) added by the test and/or measurement instrument 12 in step 1 and step 5.

In an embodiment, the above-mentioned steps can be repeated for several carrier frequencies, namely a first carrier frequency, a second carrier frequency, and so on. While doing so, the phase is altered in the same manner such that one emulated distance is tested for different carrier frequencies.

In addition, the above-mentioned steps can be, for example, repeated for several different alterations of the phase, thereby emulating different distances. Consequently, the device under test 14, for example its distance calculation algorithm, can be tested for different distances without changing the physical setup.

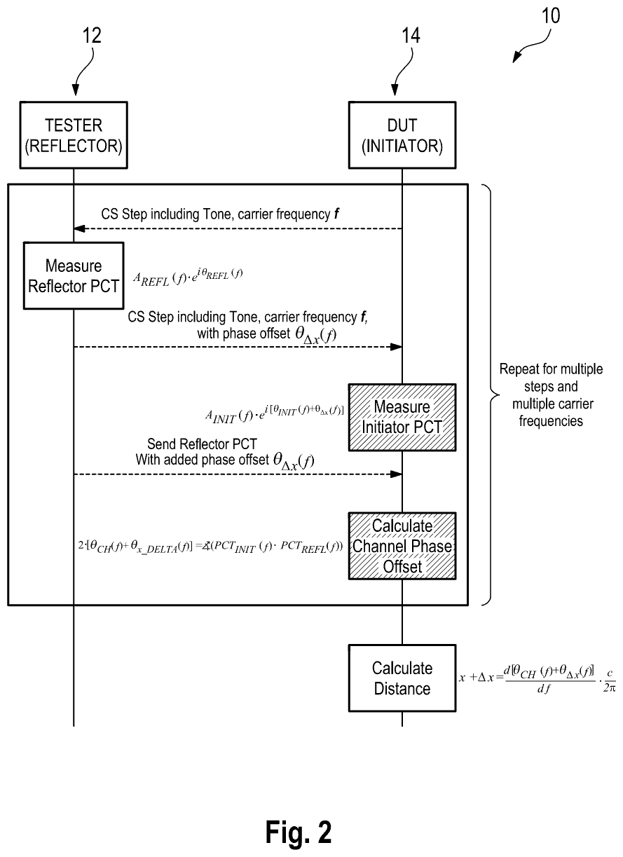

In FIG. 2, another example embodiment of the test and/or measurement system 10 for testing phase-based ranging is shown, which differs from the first one shown in FIG. 1 in that the test and/or measurement instrument 12 is the reflector whereas the device under test 14 is the initiator. Consequently, the representative method also differs as outlined hereinafter.

In a first step that relates to a channel sounding (CS) step, the device under test 14 transmits a tone with carrier frequency to the test and/or measurement instrument 12.

In a second step, the test and/or measurement instrument 12 measures its phase correction term (PCT) in response to the channel sounding procedure initiated by the device under test 14.

In a third step that relates to a channel sounding (CS) step, the test and/or measurement instrument 12 transmits a tone with carrier frequency to the device under test 14. Moreover, the test and/or measurement instrument 12 alters the phase by a phase offset θ_{Δx}(ƒ) in order to emulate a different distance between the test and/or measurement instrument 12 and the device under test 14.

In a fourth step, the device under test 14 measures its phase correction term (PCT) in response to the channel sounding procedure initiated by the test and/or measurement instrument 12. Due to the phase offset θ_{Δx}(ƒ) added, the phase correction term (PCT) is measured for a different phase.

In a fifth step, the test and/or measurement instrument 12 forwards its phase correction term (PCT) to the device under test 14, but alters the phase, namely by adding a phase offset θ_{Δx}(ƒ) to the phase correction term. In some embodiments, the same phase offset θ_{Δx}(ƒ) is added as used in the third step.

In a sixth step, the device under test 14 having both its own phase correction term (PCT) as well as the phase correction term (PCT) of the test and/or measurement instrument 12 calculates a channel phase offset.

In a seventh step, the device under test 14 calculates a distance, by using its distance calculation algorithm, thereby arriving at the emulated distance due to the altered phase, namely the phase offset θ_{Δx}(ƒ) added by the test and/or measurement instrument 12 in step 3 and step 5.

Similar to the embodiment(s) described with reference to FIG. 1, the above-mentioned steps can be repeated for several carrier frequencies, namely a first carrier frequency, a second carrier frequency, and so on. While doing so, the phase is altered in the same manner such that one emulated distance is tested for different carrier frequencies.

In addition, the above-mentioned steps, for example, can be repeated for several different alterations of the phase, thereby emulating different distances. Consequently, the device under test 14, for example its distance calculation algorithm, can be tested for different distances without changing the physical setup.

Since at least two different carrier frequencies, namely a first carrier frequency and a second carrier frequency, are used for performing the above-mentioned steps, a respective first phase correction term, e.g. the phase correction term for the first carrier frequency, is measured by the test and/or measurement instrument 12 and the device under test 14, respectively. Based on these first PCTs, a first channel phase offset is calculated, namely the channel phase offset for the first carrier frequency. Afterwards, a respective second phase correction term, e.g. the phase correction term for the second carrier frequency, is measured by the test and/or measurement instrument 12 and the device under test 14, respectively. Based on these second PCTs, a second channel phase offset is calculated, namely the channel phase offset for the second carrier frequency. For both carrier frequencies, the phase is altered in the same way such that both carrier frequencies are tested at the same emulated distance between the test and/or measurement instrument 12 and the device under test 14.

Generally, a channel sounding procedure is a group of steps exchanged in sequence to obtain data, which are then processed to calculate the distance between the devices involved, namely the test and/or measurement instrument 12 and the device under test 14. The channel sounding procedure has an initiator and a reflector, wherein the device which starts the channel sounding procedure is the initiator and the device which responds to the initiator's channel sounding procedure is the reflector. As shown above, both the test and/or measurement instrument 12 and the device under test 14 may be the initiator or the reflector, respectively.

In channel sounding procedures, typically four types or modes of channel sounding steps exist, namely calibrate one side to the other in frequency/timing (Mode 0), round trip time (RTT) exchange (Mode 1), phase based ranging (PBR) channel sounding tones exchange (Mode 2), as well as RTT and PBR measurement (Mode 3=combination of Mode 1 and Mode 2).

In an embodiment, the above-mentioned procedure can be performed for either Mode 2 or Mode 3 of the channel sounding steps, namely those steps in which phase based ranging channel sounding tones are exchanged, as discussed above.

In an embodiment, a Bluetooth Low Energy (LE) channel sounding may be used. In other words, the device under test 14 is a Bluetooth device using Bluetooth Low Energy technology.

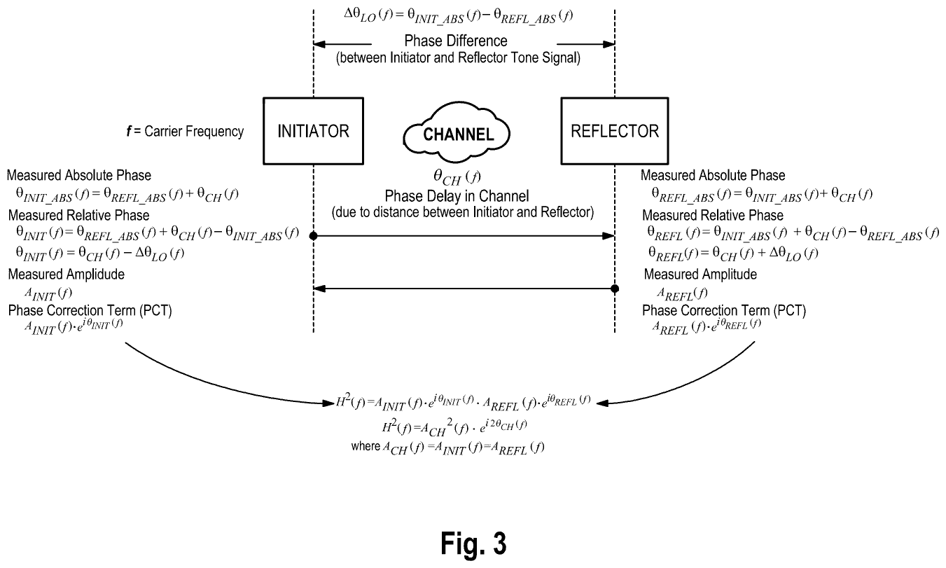

FIG. 3 illustrates an example of how the distance can be calculated based on the information exchanged.

In an embodiment, the initiator as well as the reflector both measure their respective absolute phases, their respective relative phases as well as their respective amplitudes. Based on these parameters, the phase correction terms (PCTs) can be determined/measured accordingly.

In an embodiment, the phase correction term at a given carrier frequency (tone frequency) is the transfer function H(ƒ) for the channel at the respective frequency.

In an embodiment, the phase offset can be calculated by the device under test 14 based on the following formula:

$$2 \cdot {θ}_{CH} ( f ) = ( {PCT}_{INIT} ( f ) \cdot {PCT}_{REFL} ( f ) )$$

wherein θ_{CH}(ƒ) is the phase offset, PCT_{INIT}(ƒ) is the phase correction term of the initiator, and PCT_{REFL}(ƒ) is the phase correction term of the reflector.

In an embodiment, the (emulated) distance x can be derived from the phase offset by the following formula:

$${θ}_{CH} ( f ) = 2 \cdot π \cdot f \cdot t = 2 \cdot π \cdot f \cdot \frac{x}{c}$$

Since the phase offset is determined for different carrier frequencies (tone frequencies), the formula can be expressed as follows:

$$\frac{d {θ}_{CH} ( f )}{df} = 2 \cdot π \cdot \frac{x}{c}$$

wherein dθ_{CH}(ƒ) is θ_{CH}(ƒ₁)−θ_{CH}(ƒ₂) and dƒ is ƒ₁-ƒ₂.

Based on this general concept, the phase can be actively altered by the test and/or measurement instrument 12 during the test procedures indicated above.

In an embodiment, the phase adjustment, e.g., the phase offset added, is as follows:

$${θ}_{Δ x} ( f ) = 2 \cdot π \cdot \frac{x \cdot f}{c}$$

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc.

In an embodiment, one or more of the components, such as the measurement instrument 12 and/or the device under test 14, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuitry to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuitry disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method of testing phase-based ranging, comprising:
measuring a respective first phase correction term in response to a channel sounding procedure for a first carrier frequency of a carrier signal by a device under test and a test and/or measurement instrument, respectively;
calculating a first channel phase offset for the first carrier frequency based on the first phase correction terms measured by the device under test and the test and/or measurement instrument, respectively;
measuring a respective second phase correction term for a second carrier frequency of the carrier signal by the device under test and the test and/or measurement instrument, respectively;
calculating a second channel phase offset for the second carrier frequency based on the second phase correction terms measured by the device under test and the test and/or measurement instrument, respectively,
wherein a phase is altered in order to emulate a different distance between the test and/or measurement instrument and the device under test.

2. The method according to claim 1, wherein the device under test is an initiator of the channel sounding procedure, and wherein the test and/or measurement instrument is a reflector of the channel sounding procedure.

3. The method according to claim 1, wherein the test and/or measurement instrument is an initiator of the channel sounding procedure, and wherein the device under test is a reflector of the channel sounding procedure.

4. The method according to claim 1, wherein the phase is altered by the test and/or measurement instrument when forwarding the carrier signal to the device under test.

5. The method according to claim 1, wherein the phase is altered by the test and/or measurement instrument when forwarding the phase correction term measured by the test and/or measurement instrument to the device under test.

6. The method according to claim 1, wherein the phase is altered for the first carrier frequency and/or the second carrier frequency.

7. The method according to claim 1, wherein a phase offset is added when the phase is altered.

8. The method according to claim 1, wherein the phase is altered for emulating an emulated distance between the device under test and the test and/or measurement instrument, which is different to the physical distance between the device under test and the test and/or measurement instrument, thereby obtaining a measurement value for the emulated distance.

9. The method according to claim 1, wherein the phase correction term is measured for more than two different carrier frequencies and/or wherein the channel phase offset is calculated for more than two different carrier frequencies.

10. The method according to claim 1, wherein different distances are tested without changing a physical setup comprising the device under test and the test and/or measurement instrument.

11. The method according to claim 1, wherein the channel sounding procedure comprises a Bluetooth Low Energy (LE) channel sounding.

12. A test and/or measurement system for testing phase-based ranging, the system comprising:
a device under test configured to measure a first phase correction term in response to a channel sounding procedure for a first carrier frequency of a carrier signal;
a test and/or measurement instrument configured to:
measure a first phase correction term in response to a channel sounding procedure for a first carrier frequency of a carrier signal;
calculate a first channel phase offset for the first carrier frequency based on the first phase correction terms measured by the device under test and the test and/or measurement instrument respectively,
wherein the device under test is configured to measure a second phase correction term for a second carrier frequency of the carrier signal,
wherein the test and/or measurement instrument is configured to measure a second phase correction term for a second carrier frequency of the carrier signal,
wherein the test and/or measurement system is configured to calculate a second channel phase offset for the second carrier frequency based on the second phase correction terms measured by the device under test and the test and/or measurement instrument respectively, and
wherein the test and/or measurement system is configured to alter a phase in order to emulate a different distance between the test and/or measurement instrument and the device under test.

13. The system according to claim 12, wherein the device under test is an initiator of the channel sounding procedure, and wherein the test and/or measurement instrument is a reflector of the channel sounding procedure.

14. The system according to claim 12, wherein the test and/or measurement instrument is an initiator of the channel sounding procedure, and wherein the device under test is a reflector of the channel sounding procedure.

15. The system according to claim 12, wherein the test and/or measurement instrument is configured to alter the phase when forwarding the carrier signal to the device under test.

16. The system according to claim 12, wherein the test and/or measurement instrument is configured to alter the phase when forwarding the phase correction term measured by the test and/or measurement instrument to the device under test.

17. The system according to claim 12, wherein the test and/or measurement instrument is configured to alter the phase for the first carrier frequency and/or the second carrier frequency.

18. The system according to claim 12, wherein the test and/or measurement instrument is configured to add a phase offset when the phase is altered.

19. The system according to claim 12, wherein the test and/or measurement instrument is configured to alter the phase for emulating an emulated distance between the device under test and the test and/or measurement instrument, which is different to the physical distance between the device under test and the test and/or measurement instrument, thereby obtaining a measurement value for the emulated distance.

20. The system according to claim 12, wherein the channel sounding procedure comprises a Bluetooth Low Energy (LE) channel sounding.
